(19) United States
(12) Patent Application Publication
(10) Pub. No.: US 2022/0089905 A1
(43) Pub. Date: Mar. 24, 2022

(54) POROUS FILM, OPTICAL ELEMENT, OPTICAL SYSTEM, INTERCHANGEABLE LENS, OPTICAL DEVICE, AND MANUFACTURING METHOD OF POROUS FILM

(71) Applicant: NIKON CORPORATION, Tokyo (JP)

(72) Inventors: Ryoko SUZUKI, Yokohama-shi (JP); Kenji YONEYAMA, Fujisawa-shi (JP); Masahiro OSAKA, Kawasaki-shi (JP)

(73) Assignee: NIKON CORPORATION, Tokyo (JP)

(21) Appl. No.: 17/483,541

(22) Filed: Sep. 23, 2021

Related U.S. Application Data
(63) Continuation of application No. PCT/JP2020/014100, filed on Mar. 27, 2020.

(30) Foreign Application Priority Data
Mar. 28, 2019 (JP) 2019-063714

(51) Int. Cl. C09D 183/02; G02B 1/115

(52) U.S. Cl. CPC C09D 183/02; C08K 3/36; G02B 1/115

(57) ABSTRACT

A porous film is a porous film having a silica particle, wherein a refractive index is 1.1 to 1.25, and a contact angle with respect to water is equal to or more than 40°.

### CROSS-REFERENCE TO RELATED APPLICATION

This is a Continuation Application of International Application No. PCT/JP2020/014100, filed on Mar. 27, 2020, which claims priority on Japanese Patent Application No. 2019-063714, filed on Mar. 28, 2019. The contents of the aforementioned applications are incorporated herein by reference.

### BACKGROUND

### Field of the Invention

The present invention relates to a porous film, an optical element, an optical system, an interchangeable lens, an optical device, and a porous film-manufacturing method.

### Background

For example, Japanese Unexamined Patent Application, First Publication No. H8-122501 discloses a low refractive index antireflection film having a refractive index of 1.28 to 1.38. Such a low antireflection film is required to have a low refractive index and also have excellent environmental tolerance.

### SUMMARY

According to a first aspect, a porous film is a porous film having a silica particle, wherein a refractive index is 1.1 to 1.25, and a contact angle with respect to water is equal to or more than 40°.

According to a second aspect, a porous film is a porous film having a silica particle, wherein a refractive index is 1.1 to 1.25, and a surface of the porous film has a trimethylsilyl group.

According to a third aspect, a porous film is a porous film having a silica particle, wherein a refractive index is 1.1 to 1.25, and a surface of the porous film is treated with a silane coupling agent.

According to a fourth aspect, a porous film-manufacturing method includes: a step of mixing a solvent that includes a tertiary amine, water, and a methoxypropanol (PGME) with a silicon compound and preparing a mixed solution; a step of agitating the mixed solution; a step of applying the mixed solution after agitation on a substrate and forming a coating film; and a step of heating the coating film and forming a porous film.

### BRIEF DESCRIPTION OF THE DRAWINGS

FIG. 1 is a flowchart showing a manufacturing method of a porous film in an embodiment.

FIG. 2 is a perspective view of an imaging device in the embodiment.

FIG. 3 is a front view of another example of an imaging device in the embodiment.

FIG. 4 is a back view of another example of the imaging device in the embodiment.

FIG. 5A is a view showing a refractive index of a porous film in a comparative example.

FIG. 5B is a view showing a refractive index of a porous film in an example.

FIG. 5C is a view showing a refractive index of the porous film in the example.

FIG. 5D is a view showing a refractive index of the porous film in the example.

FIG. 6A is a view showing the scattering of the porous film in the comparative example with respect to light having a wavelength of 350 nm and light having a wavelength of 544 nm.

FIG. 6B is a view showing the scattering of the porous film in the example with respect to light at a wavelength of 350 nm and at a wavelength of 544 nm.

FIG. 6C is a view showing the scattering of the porous film in the example with respect to light at a wavelength of 350 nm and at a wavelength of 544 nm.

FIG. 6D is a view showing the scattering of the porous film in the example with respect to light at a wavelength of 350 nm and at a wavelength of 544 nm.

FIG. 7A is a view showing a contact angle of the porous film in the comparative example with respect to water.

FIG. 7B is a view showing a contact angle of the porous film in the example with respect to water.

FIG. 7C is a view showing a contact angle of the porous film in the example with respect to water.

FIG. 7D is a view showing a contact angle of the porous film in the example with respect to water.

FIG. 8A is a view showing a result of performing an IR measurement with respect to the porous film of the comparative example and confirming the presence or absence of an absorption band near 1259 cm⁻¹.

FIG. 8B is a view showing a result of performing an IR measurement with respect to the porous film of the example and confirming the presence or absence of an absorption band near 1259 cm⁻¹.

FIG. 8C is a view showing a result of performing an IR measurement with respect to the porous film of the example and confirming the presence or absence of an absorption band near 1259 cm⁻¹.

FIG. 8D is a view showing a result of performing an IR measurement with respect to the porous film of the example and confirming the presence or absence of an absorption band near 1259 cm⁻¹.

### DESCRIPTION OF EMBODIMENTS

—Embodiments—a porous film according to an embodiment will be described with reference to the drawings. The porous film according to the present embodiment is a porous film that is constituted of silica particles (SiO₂ particles), that has a low refractive index, and that has excellent environmental tolerance.

The porous film of the present embodiment is constituted of a gel network of silica particles and includes a structure having a large number of pores of a several nanometers in size in the film. The refractive index of the porous film of the present embodiment is in a range of 1.1 to 1.25 and can be more preferably in a range of 1.17 to 1.23. The refractive index in the present description means a refractive index with respect to light having a wavelength of 550 nm. In the porous film of the present embodiment, a contact angle with respect to water is equal to or more than 40° and can be more preferably equal to or more than 45°. In order to realize this contact angle, a surface of the porous film has a trimethylsilyl group. Further, in the porous film of the present embodiment, the scattering at a wavelength of 350 nm is equal to or less than 1000 ppm and can be more preferably equal to or less than 900 ppm.

Hereinafter, a method for manufacturing the above porous film is described.

By hydrolyzing and performing dehydrating condensation on the silicon compound under a base catalyst, porous particles of the present embodiment are formed. A tetramethyl orthosilicate (TMOS) is used as the silicon compound. The tetramethyl orthosilicate is added to a solvent that contains a tertiary amine, water, and a methoxypropanol (PGME) and is agitated. For example, a triethylamine can be used as the tertiary amine. A predetermined amount of nitric acid may be added to the solvent in a container in order to prolong the lifetime of the solution. The agitation is performed at about room temperature. When the temperature at this time is too high, the reaction speed is too fast, and it is difficult to control the refractive index of the porous film that is eventually formed. Conversely, when the temperature is too low, the reaction speed is too slow, and the porous film that is eventually formed becomes brittle. Accordingly, the temperature during agitation can be preferably 15 to 30° C. and can be further preferably 20 to 25° C. Further, the agitation time at this time is also a condition that affects the refractive index of the formed porous film. The agitation time is suitably set in accordance with the desired refractive index and can be, for example, in a range of 12 to 100 hours. As the agitation time increases, the refractive index of the porous film becomes lower. By the agitation, the tetramethyl orthosilicate is hydrolyzed as follows, and silica particles are formed in the solution.

Si(OMe)₄+2H₂O→SiO₂+4MeOH

The solution after the agitation is applied on a substrate, and a coating film is formed by a film formation process. The film formation process is performed by using, for example, a spin coater. By appropriately setting a condition that is set when the spin coater is used, the film thickness of the coating film can be an arbitrary thickness. In the formed coating film, silica particles are connected together, and a gel network is formed. The coating is heated and is hardened. As a heating condition at this time, the heating temperature can be in a range of 140 to 180° C., and the heating time can be in a range of 1 to 5 hours. Specifically, the heating temperature can be, for example, 160° C., and the heating time can be, for example, 3 hours. Since the porous film that is eventually formed becomes brittle when the heating time is too long, temperature management is important. The gel network is dehydrated and condensed by the heating process, and a porous film having a large number of holes of several nanometers in size is formed. After the heating, the coating film is left to stand at room temperature for a predetermined period of time to be thereby cooled, and the formation of the porous film is completed.

A large amount of OH groups are present on the surface of the porous film formed as described above. Since the OH groups on the surface of the porous film are condensed with each other in a high-temperature, high-humidity environment and become a cause for changing the refractive index of the porous film or changing the film thickness, the porous film in a state where a large amount of OH groups are present becomes a film having poor environmental tolerance. Accordingly, in the present embodiment, the surface of the porous film is treated with a silane coupling agent, and the amount of OH groups is reduced. The silane coupling agent treatment is performed using hexamethyldisilazane (HMDS). The silane coupling agent treatment may employ any of a gas phase treatment, a liquid phase treatment, and a mist treatment. When the gas phase treatment is performed, a substrate on which a porous film is formed is left to stand at room temperature for a predetermined period of time in an environment (in a sealed container) where the hexamethyldisilazane is vaporized. Then, heating is performed at a predetermined temperature for a predetermined period of time. When the liquid phase treatment is performed, a substrate on which a porous film is formed is immersed in a solution of hexamethyldisilazane, is left in a state where ultrasonic vibration is applied for a predetermined period of time, and is then heated at a predetermined temperature for a predetermined period of time. When the mist treatment is performed, a substrate on which a porous film is formed is placed in a container, and hexamethyldisilazane in a mist state is filled into the container. After a predetermined period of time elapses, the substrate is removed from the container, is washed, and is then heated at a predetermined temperature for a predetermined period of time.

By the silane coupling agent treatment described above, the OH group on the surface of the porous film is joined (coupled) to the trimethylsilyl group of the silane coupling agent. That is, the trimethylsilyl group is formed on the surface of the porous film. As a result, in the porous film, a contact angle with respect to water becomes relatively larger than that before the silane coupling agent treatment and becomes a value described above. That is, since the amount of OH groups on the surface of the porous film is reduced by the silane coupling agent treatment, and the refractive index change or the film thickness change of the porous film that originates from the OH groups in the high-temperature, high-humidity environment is prevented, the porous film has high environmental tolerance.

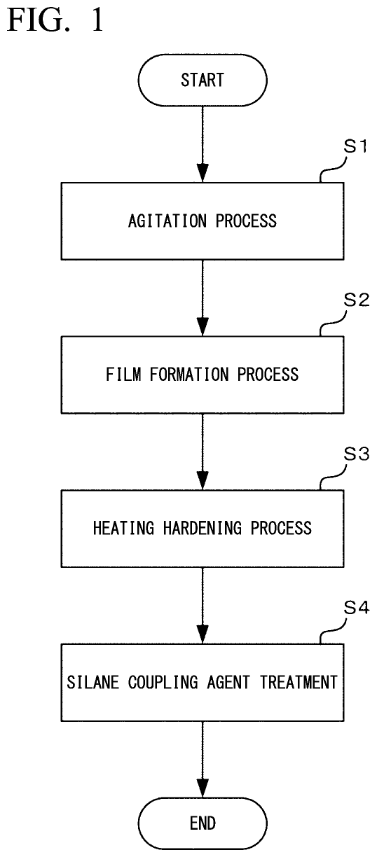

The manufacturing method of the above-described porous film is described using a flowchart shown in FIG. 1.

In Step S1, the tetramethyl orthosilicate (TMOS) is added to a solvent that contains a tertiary amine, water, and methoxypropanol (PGME) and is agitated at room temperature (agitation process), and the process proceeds to Step S2. The time (reaction time) of agitation is determined based on a required refractive index of the porous film to be manufactured.

In Step S2, a film formation process is performed in which a solution after agitation is applied on a substrate fixed on a rotation table of a spin coater, then the rotation table is rotated, and a coating film is formed, and the process proceeds to Step S3. In Step S3, the formed coating film is heated, for example, at a heating temperature of 160° C. for a heating time of 3 hours and is hardened (heating hardening process), a porous film is formed, and the process proceeds to Step S4. In Step S4, the surface of the porous film is treated with a silane coupling agent, and the amount of OH groups on the surface of the porous film is reduced. The silane coupling agent treatment is performed using hexamethyldisilazane (HMDS) by any of the gas phase treatment, the liquid phase treatment, and the mist treatment. In this way, the porous film according to the present embodiment is obtained.

The porous film obtained in this way can be suitably used as an antireflection film. The antireflection film may be a single layer film or may be a multilayer film. When the antireflection film is a multilayer film, it is known that when the refractive index of the used film material is larger, or by using a low refractive index film for the outermost layer, the optical performance is improved, or the number of multilayer films is reduced even at the same optical performance. In particular, it has been clarified by simulation that by using a low refractive index film having a refractive index of 1.30 or less only for the outermost layer, the optical performance can be extremely enhanced. Since the porous film of the present embodiment has a low refractive index of 1.1 to 1.25, the porous film can be suitably used as a configuration of the antireflection film and can be suitably used particularly as the outermost layer of the multilayer film that constitutes the antireflection film. The outermost layer means a layer that is the most distant from a base material of the multilayer film.

An optical element that includes the antireflection film described above can be suitably used, for example, as a lens or the like. An optical system that includes such a lens includes, for example, an objective lens, a collecting lens, an imaging lens, an interchangeable lens for a camera, and the like. These can be used for an imaging device such as a lens interchangeable camera or a lens non-interchangeable camera or an optical device such as a microscope. The optical device is not limited to the imaging device or the microscope described above and also includes a video camera, a teleconverter, a telescope, a binocular, a monocular viewer, a laser distance meter, a projector, and the like. An example of the imaging device is described below.

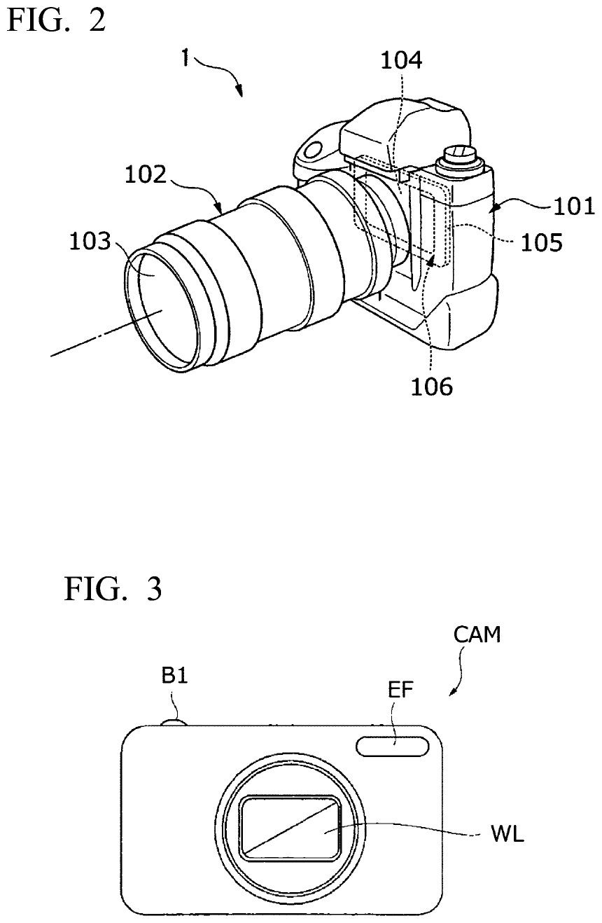

FIG. 2 is a perspective view of an imaging device having an optical system that includes an antireflection film including a porous film according to the present embodiment. An imaging device 1 is a so-called digital single-lens reflex camera (lens interchangeable camera), and an imaging lens 103 (optical system) has a lens that includes an antireflection film including a porous film according to the present embodiment. A lens barrel 102 is detachably attached to a lens mount (not shown) of the camera body 101. Light that has passed through the imaging lens 103 of the lens barrel 102 is imaged on a sensor chip (solid-state imaging device) 104 of a multichip module 106 disposed on a back side of the camera body 101. The sensor chip 104 is a bare chip such as a so-called CMOS image sensor, and the multichip module 106 is, for example, a COG (Chip On Glass) type module in which the sensor chip 104 is mounted by a bare chip mounting on a glass substrate 105.

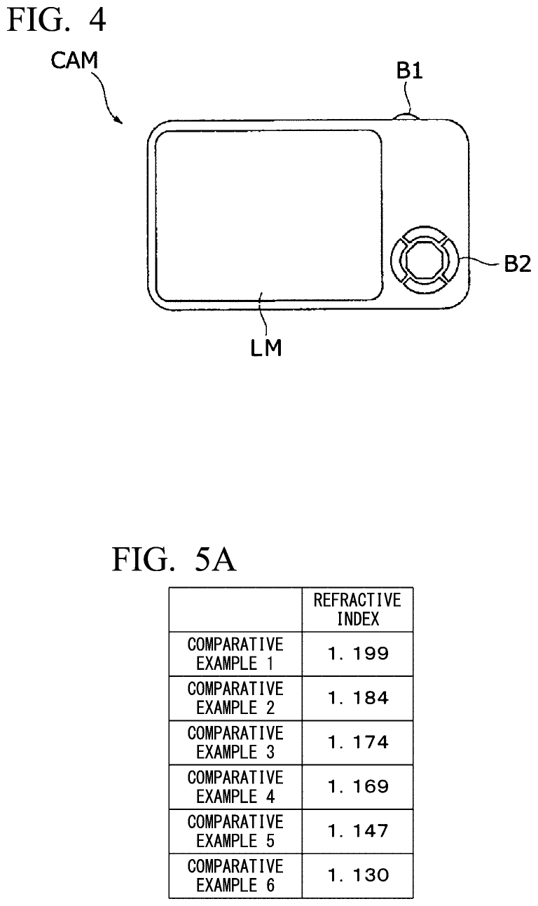

FIG. 3 is a front view of another example of an imaging device having an optical element that includes an antireflection film including a porous film according to the present embodiment, and FIG. 4 is a back view of the imaging device shown in FIG. 3. An imaging device CAM is a so-called digital still camera (lens non-interchangeable camera), and an imaging lens WL (optical system) has a lens that includes an antireflection film including a porous film according to the present embodiment.

In the imaging device CAM, when a power button (not shown) is pressed, a shutter (not shown) of an imaging lens WL is opened, light from a photographic subject (object) is collected by the imaging lens WL, and an image is imaged on an imaging element disposed on an image surface. The subject image imaged on the imaging element is displayed on a LCD monitor LM arranged on a rear portion of the imaging device CAM. After a photographer determines a composition of a subject image while viewing the LCD monitor LM, a release button B1 is pressed, the subject image is captured by the imaging element and is recorded and stored in a memory (not shown). An auxiliary light-emitting unit EF that emits auxiliary light when the subject image is dark, a function button B2 that is used for various condition settings or the like of the imaging device CAM, and the like are arranged on the imaging device CAM.

A higher antireflection performance is required for the optical systems used in the camera or the like. In order to achieve this, it is effective to use the porous film according to the present embodiment as the antireflection film.

An example of the porous film according to the above embodiment is described.

### EXAMPLE

In the present example, the porous film is formed by the following procedure. 1-Methoxy-2-propanol (PGME) (Fujifilm Wako Pure Chemical) of 54.43 g is placed in a resin bottle. Next, triethylamine (Tokyo Chemical) of 36.1 μL and pure water of 1.731 mL are each measured using a micropipette, are added to the resin bottle, and are agitated by rotating a magnetic stirrer at a rotation speed of 600 rpm for 5 minutes, and a base solvent is formed.

Tetramethyl orthosilicate (TMOS) (Tokyo Kasei) of 7.31 g is added to the base solvent described above and is agitated at room temperature for a predetermined period of time. Further, 1-methoxy-2-propanol (PGME) of 27.2 g is added to dilute such that a content ratio of the PGME is 70 wt %, and a coating solution is obtained. When nitric acid is added in order to prolong the lifetime of the coating solution, nitric acid (1.42) (Fujifilm Wako Pure Chemical) of 11 μL of may be added dropwise. The coating solution is contained in a syringe and is added dropwise onto a substrate through a syringe filter having a mesh of 5.0 μm. The substrate on which the coating solution is added dropwise is fixed to a rotation table of the spin coater, the rotation table is accelerated to 3000 rpm in 5 seconds, and the rotation is held in that state for 30 seconds, is then decelerated in 5 seconds, and is stopped. A rotation control of the rotation table is performed according to a preset program. The coating film formed on the substrate by the spin coater is heated using an oven under a condition of a heating temperature of 160° C. and a heating time of 3 hours. After the heating, the coating film is left to stand at room temperature for 24 hours. By the above procedure, a porous film is formed on the substrate. This state is called a test piece in the following description.

A silane coupling agent treatment is performed on the porous film of the test piece. As described above, a method of performing the silane coupling agent treatment includes the gas phase treatment, the liquid phase treatment, and the mist treatment. The process conditions are described below.

<Gas phase Treatment>

A test piece and hexamethyldisilazane (HMDS) (Tokyo Chemical) of 0.614 μL are placed in a sealed container having a volume of about 1 L and are left to stand at room temperature for 24 hours. Then, the test piece that is removed from the sealed container is heated at a heating temperature of 60° C. for a heating time of 30 minutes.

### <Liquid Phase Treatment>

Hexamethyldisilazane (HMDS) is diluted with methanol to 30 wt %, and a HMDS diluted solution is prepared. The test piece is immersed in the HMDS diluted solution and is treated for 20 minutes by applying ultrasonic waves. The test piece after the treatment is washed by ultrasonic cleaning in the methanol for 1 minute and is then heated at a heating temperature of 60° C. for a heating time of 30 minutes.

### <Mist Treatment>

The test piece is heated at a heating temperature of 70° C. for a heating time of 30 minutes. After the heat treatment, the test piece is placed in a container, and a mist of hexamethyldisilazane (HMDS) is filled in the container using a nebulizer. After generating the mist by the nebulizer for 5 minutes and then allowing 5 minutes to elapse in a state where the generation of the mist is stopped, the test piece is removed from the container. The removed test piece is heated at a heating temperature of 70° C. for a heating time of 30 minutes. The test piece after the heat treatment is immersed in methanol and is ultrasonically washed for 2 minutes. Then, the test piece is washed with pure water and is then heated at a heating temperature of 70° C. for a heating time of 30 minutes.

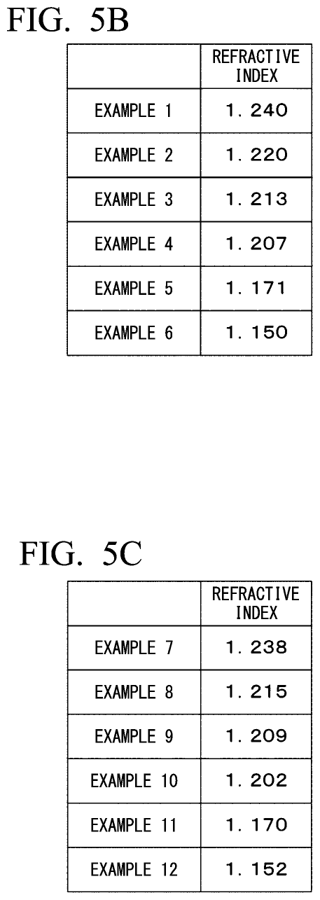

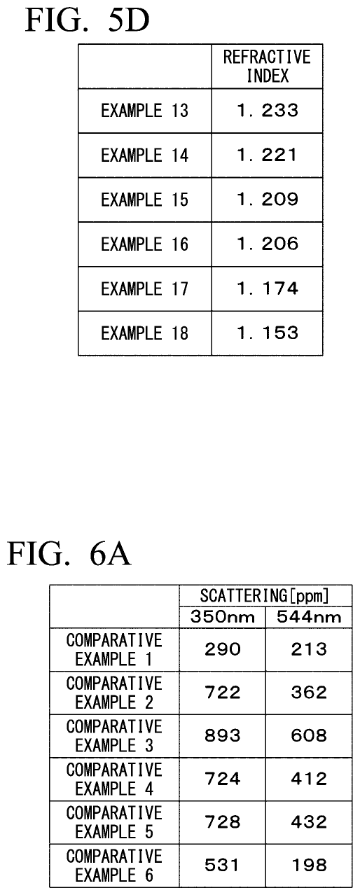

FIG. 5A to FIG. 5D are views showing a refractive index of comparative examples and examples of porous films manufactured by the manufacturing method described above.

FIG. 5A shows refractive indexes of Comparative Examples 1 to 6. Comparative Examples 1-6 are porous films in which the silane coupling agent treatment is not applied to the surface. In Comparative Example 1, the agitation time of the mixed solution of the base solvent and tetramethyl orthosilicate (TMOS) at the time of manufacturing of the porous film is 15 hours. Comparative Examples 2 to 6 are porous films in which the agitation time is 18 hours, 21 hours, 24 hours, 48 hours, and 96 hours, respectively.

FIG. 5B shows refractive indexes of Examples 1 to 6. In Examples 1 to 6, the silane coupling agent treatment by the gas phase treatment is applied to the surface of a porous film formed according to conditions similar to those of Comparative Examples 1 to 6, respectively. That is, Examples 1 to 6 are porous films in which the agitation time is 15 hours, 18 hours, 21 hours, 24 hours, 48 hours, and 96 hours, respectively.

FIG. 5C shows refractive indexes of Examples 7 to 12. In Examples 7 to 12, the silane coupling agent treatment by the liquid phase treatment is applied to the surface of a porous film formed according to conditions similar to those of Comparative Examples 1 to 6, respectively. That is, Examples 7 to 12 are porous films in which the agitation time is 15 hours, 18 hours, 21 hours, 24 hours, 48 hours, and 96 hours, respectively. FIG. 5D shows refractive indexes of Examples 13 to 18. In Examples 13 to 18, the silane coupling agent treatment by the mist treatment is applied to the surface of a porous film formed according to conditions similar to those of Comparative Examples 1 to 6, respectively. That is, Examples 13 to 18 are porous films in which the agitation time is 15 hours, 18 hours, 21 hours, 24 hours, 48 hours, and 96 hours, respectively.

As shown in FIG. 5B to FIG. 5D, the refractive index of the porous film becomes smaller as the agitation time of the base solvent and tetramethyl orthosilicate (TMOS) at the time of manufacturing increases. Further, the refractive index of the porous film by applying the silane coupling agent treatment to the surface is larger than that before the silane coupling agent treatment is applied. As shown in FIG. 5B to FIG. 5D, the refractive index is smaller than 1.25 regardless of the presence or absence of the silane coupling agent treatment. Although not described in FIG. 5B to FIG. 5D, when the reaction time is equal to or more than 96 hours, the refractive index of the formed porous film is smaller than 1.1.

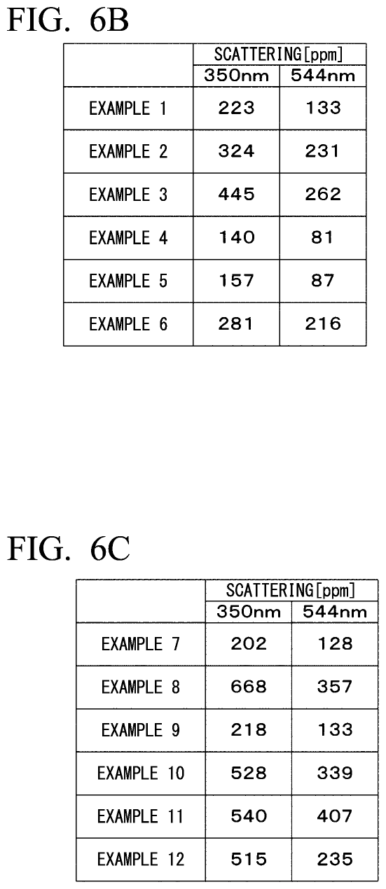

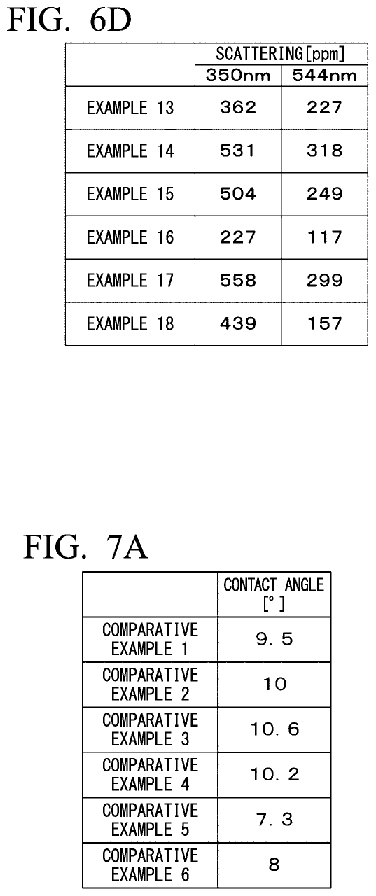

FIG. 6A to FIG. 6D are views showing a relationship between the porous film of each example and each comparative example described above and the scattering with respect to light having a wavelength of 350 nm and light having a wavelength of 544 nm. FIG. 6A shows the scattering of Comparative Examples 1 to 6, FIG. 6B shows the scattering of Examples 1 to 6, FIG. 6C shows the scattering of Examples 7 to 12, and FIG. 6D shows the scattering of Examples 13 to 18. The value of scattering shown in FIG. 6A to FIG. 6D shows the ratio of scattering light with respect to incident light on the porous film. The scattering light is the sum of forward scattering and backward scattering that are detected using an integrating sphere. All of the values of scattering of the porous films of the examples are values equal to or less than 1000 ppm, and it can be found that the scattering of the porous film manufactured by the manufacturing method of the present example is sufficiently small. That is, the porous film of the present example has a property of having a smooth surface and having a fine internal structure. Thereby, the porous film of the present example can be used as a thin film for an optical member in a visible light region.

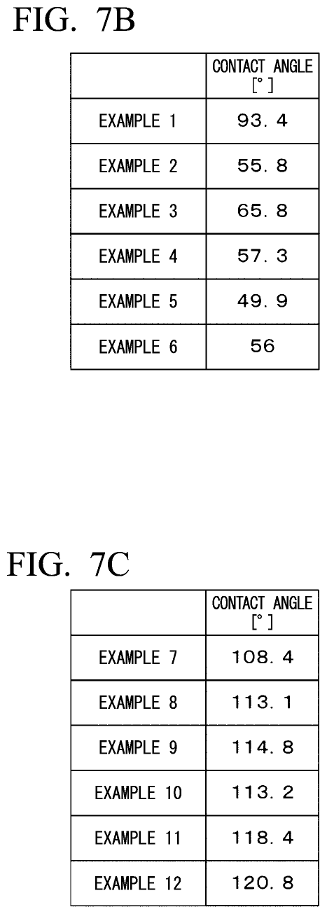

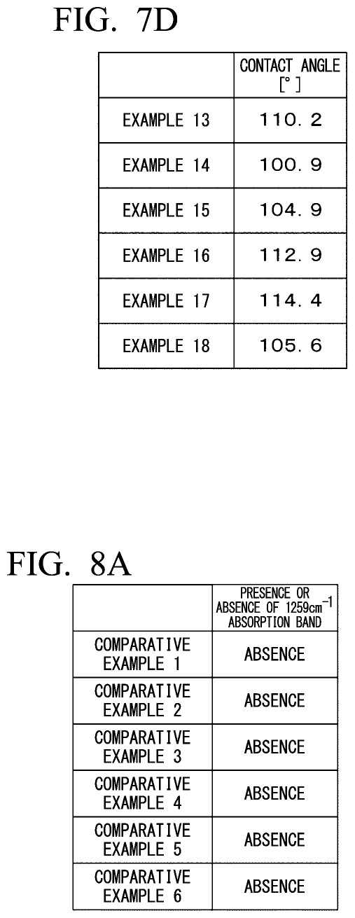

FIG. 7A to FIG. 7D are views showing a contact angle with respect to water of the porous film of each example and each comparative example described above. FIG. 7A shows contact angles with respect to water of the porous films of Comparative Examples 1 to 6, FIG. 7B shows contact angles with respect to water of the porous films of Examples 1 to 6, FIG. 7C shows contact angles with respect to water of the porous films of Examples 7 to 12, and FIG. 7D shows contact angles with respect to water of the porous films of Examples 13 to 18. As shown in FIG. 7A, since the silane coupling agent treatment is not applied to the porous films of Comparative Examples 1 to 6, the contact angle is 7.3° to 14.7° and is small. On the other hand, as shown in FIG. 7B to FIG. 7D, it can be found that all of the contact angles with respect to water of the porous films of Examples 1 to 18 in which the silane coupling agent treatment is applied to the surface exceed 40° and are much larger than the contact angles of the porous films of Comparative Examples 1 to 6. It is estimated that by applying the silane coupling agent treatment, a trimethylsilyl group is formed on the surface of the porous film, and thereby, the contact angle with respect to water is increased, that is, the amount of OH groups on the surface of the porous film is reduced.

The presence or absence of the trimethylsilyl group on the surface of the porous film can be determined by an IR (infrared absorption spectroscopy) measurement. That is, the presence of the trimethylsilyl group can be confirmed when, in the IR measurement, absorption near 1259 cm⁻¹ due to a Si—C bond specifically included in the trimethylsilyl group is observed.

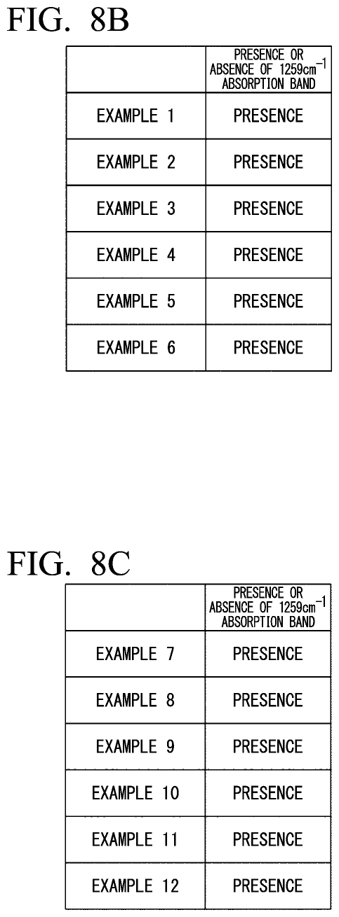

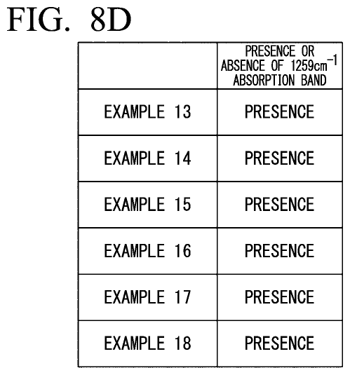

FIG. 8A to FIG. 8D show results of performing the IR measurement of the examples and comparative examples described above and confirming the presence or absence of an absorption band near 1259 cm⁻¹. FIG. 8A, FIG. 8B, FIG. 8C, and FIG. 8D show IR measurement results of the porous films of Comparative Examples 1 to 6, Examples 1 to 6, Examples 7 to 12, and Examples 13 to 18, respectively. With respect to Comparative Examples 1 to 6, the absorption band was not confirmed near 1259 cm⁻¹, but with respect to all of Examples 1 to 18, the absorption band was confirmed near 1259 cm⁻¹. That is, it can be seen that the trimethylsilyl group is present on the surface of the porous films of Examples 1 to 18. It is estimated that this shows a large contact angle with respect to water.

According to the above-described embodiment, the following effects are obtained. (1) The porous film has silica particles wherein the refractive index is 1.1 to 1.25, and the contact angle with respect to water is equal to or more than 40°. Thereby, the porous film has a low refractive index and a high environmental tolerance and therefore can be used for applications such as a thin film of an optical member.

(2) The silane coupling agent treatment is applied to the OH group on the surface, and the porous film has the trimethylsilyl group. Thereby, the contact angle of the porous film is increased. That is, since the OH group amount on the surface of the porous film is reduced, it is possible to prevent the refractive index change or the film thickness change of the porous film that originates from the OH group in the high-temperature, high-humidity environment.

(3) In the porous film, the scattering at a wavelength of 350 nm is smaller than 1000 ppm. Thereby, the porous film is a low scattering film and therefore can be used for applications such as an antireflection film of an optical member.

(4) A mixed solution is prepared by mixing a solvent that includes a tertiary amine, water, and methoxypropanol (PGME) with a silicon compound, the mixed solution is agitated, a coating film is formed by applying the mixed solution after agitation on a substrate, and a porous film is formed by heating the coating film. Thereby, by a simple process, it is possible to manufacture a porous film having a low refractive index safely without using hydrofluoric acid or the like.

Unless the features of the present invention are impaired, the present invention is not limited to the embodiments described above, and other aspects that may be considered within the scope of the technical ideas of the present invention are also included within the scope of the present invention.

What is claimed is:

1. A porous film having a silica particle,
wherein a refractive index is 1.1 to 1.25, and
a contact angle with respect to water is equal to or more than 40°.

2. The porous film according to claim 1,
wherein a surface of the porous film has a trimethylsilyl group.

3. A porous film having a silica particle,
wherein a refractive index is 1.1 to 1.25, and
a surface of the porous film has a trimethylsilyl group.

4. A porous film having a silica particle,
wherein a refractive index is 1.1 to 1.25, and
a surface of the porous film is treated with a silane coupling agent.

5. The porous film of according to claim 1,
wherein scattering at a wavelength of 350 nm is equal to or less than 1000 ppm.

6. An optical element, comprising:
an antireflection film constituted of a single layer film on a base material,
wherein the single layer film is the porous film according to claim 1.

7. An optical element, comprising:
an antireflection film constituted of a multilayer film on a base material,
wherein at least one layer of the multilayer film is the porous film according to claim 1.

8. The optical element according to claim 7,
wherein an outermost layer of the multilayer film is the porous film.

9. The optical element according to claim 6,
wherein the base material is a lens.

10. An optical system, comprising:
the optical element according to claim 6.

11. An interchangeable lens, comprising:
the optical system according to claim 10.

12. An optical device, comprising:
the optical system according to claim 10.

13. A porous film-manufacturing method, comprising:
a step of mixing a solvent that includes a tertiary amine, water, and a methoxypropanol (PGME) with a silicon compound and preparing a mixed solution;
a step of agitating the mixed solution;
a step of applying the mixed solution after agitation on a substrate and forming a coating film; and
a step of heating the coating film and forming a porous film.

14. The porous film-manufacturing method according to claim 13,
wherein in the step of agitating the mixed solution, the mixed solution is agitated at 15 to 30° C.

15. The porous film-manufacturing method according to claim 13,
wherein in the step of agitating the mixed solution, the mixed solution is agitated for 12 to 100 hours.

16. The porous film-manufacturing method according to claim 13,
wherein in the step of forming the porous film, the coating film is heated to 140 to 180° C.

17. The porous film-manufacturing method according to claim 13,
wherein in the step of forming the porous film, the coating film is heated for 1 to 5 hours.

18. The porous film-manufacturing method according to claim 13,
wherein the silicon compound is a tetramethyl orthosilicate.

19. The porous film-manufacturing method according to claim 13,
wherein the tertiary amine is a triethylamine.

20. The porous film-manufacturing method according to claim 13,
wherein a silane coupling agent treatment is performed on a surface of the porous film.

21. The porous film-manufacturing method according to claim 20,
wherein the silane coupling agent treatment is performed using a hexamethyldisilazane (HMDS).

22. The porous film-manufacturing method according to claim 20,
wherein the silane coupling agent treatment is a gas phase treatment, a liquid phase treatment, or a mist treatment.
